(19) United States
(12) Patent Application Publication
(10) Pub. No.: US 2012/0139836 A1
(43) Pub. Date: Jun. 7, 2012

(54) INFORMATION PROVIDING DEVICE

(75) Inventors: Yu Naito, Nagoya (JP); Yasushi Suda, Nagoya (JP)

(73) Assignee: ELMO COMPANY, LIMITED, Nagoya (JP)

(21) Appl. No.: 13/311,889

(22) Filed: Dec. 6, 2011

(30) Foreign Application Priority Data
Dec. 7, 2010 (JP) 2010-272125

(51) Int. Cl. G09G 5/08

(52) U.S. Cl. 345/157

(57) ABSTRACT

An information providing apparatus equipped with a camera includes: an imaging unit configured to take an image of a preset area with the camera and obtain the taken image; a display output module configured to display the taken image as a displayed image on an image display device; a receiver configured to wirelessly receive operating information, which regards a user's operation performed via a pointing device and includes at least coordinates-related information, from the pointing device; and an operating information processor configured to perform processing based on the received operating information and display result of the processing to be superimposed on the displayed image, wherein the imaging unit, the display output module, the receiver and the operating information processor are all accommodated in a single housing.

### CROSS-REFERENCE TO RELATED APPLICATION

The present application claims priority from Japanese application P2010-272125A filed on Dec. 7, 2010, the content of which is hereby incorporated by reference into this application.

### BACKGROUND

1. Field of the Invention

The present invention relates to an information providing device.

2. Description of the Related Art

Recently, information providing devices have widely been used for presentations. The known technology relating to the information providing devices includes, for example, the technology disclosed in JP 2010-245690.

When a pointing device, especially a wireless pointing device, is used for operating the information providing device, the operating information transmitted from the pointing device is to be processed first by a computer connected with the information providing device and the processing result is sent from the computer to the information providing device. The computer is thus essential as the processor to use the pointing device for the information providing device.

### SUMMARY

Consequently, in order to address the problem described above, there is a need to enable a pointing device to be used for an information providing device without the computer.

In order to achieve at least part of the foregoing, the present invention provides various aspects and embodiments described below.

According to a first aspect of the invention, there is provided an information providing apparatus equipped with a camera, comprising: a single housing; an imaging unit configured to take an image of a preset area with the camera and obtain the taken image; a display output module configured to display the taken image as a displayed image on an image display device; a receiver configured to wirelessly receive operating information, which regards a user's operation performed via a pointing device and includes at least coordinates-related information, from the pointing device; and an operating information processor configured to perform processing based on the received operating information and display a result of the processing to be superimposed on the displayed image, wherein the imaging unit, the display output module, the receiver, and the operating information processor are all accommodated in the single housing.

In the information providing device according to the first aspect, the operating information processor for processing the operating information received wirelessly from the pointing device is integrally provided inside the single housing. There is accordingly no need to provide a separate computer for processing the operating information.

According to a second aspect of the invention, there is provided the information providing device, wherein the pointing device is a tablet terminal having plane and enabling the user to specify a position on the plane and thereby specify a position on the displayed image.

The information providing device according to the second aspect uses the tablet terminal as the pointing device. This improves the user's convenience when the user performs drawing operations on the displayed image on the image display device by the information providing device.

According to a third aspect of the invention, there is provided the information providing device, wherein the operating information includes coordinate information for identifying a change in position on the displayed image specified by the user via the pointing device as a change in coordinates within a preset period of time, and the operating information processor comprises: an interpolator configured to interpolate the change in coordinates within the preset period of time identified by the coordinate information with interpolated coordinate information representing a change in coordinates within a shorter period of time than the preset period of time; and an interpolation display module configured to display a change in position on the displayed image specified by the user via the pointing device to be superimposed on the displayed image, based on the interpolated coordinate information.

The information providing device according to the third aspect includes the interpolation display module and thereby ensures displaying a change in position on the displayed image specified by the user via the pointing device as a smooth motion change.

According to a fourth aspect of the invention, there is provided the information providing device, wherein when the user performs a drawing operation as the operation performed via the pointing device, the interpolation display module comprises a drawing display module configured to generate a drawn image corresponding to the user's drawing operation, based on the interpolated coordinate information regarding a change in position on the displayed image specified by the user during the drawing operation via the pointing device, and superimpose the drawn image on the taken image to generate a composite drawn image, and the display output module displays the composite drawn image, in place of the taken image, on the image display device.

In the information providing device according to the fourth aspect, the interpolation display module generates the drawn image, based on the interpolated coordinate information and thereby enables line drawing included in the drawn image to be created as smooth line work.

According to a fifth aspect of the invention, there is provided the information providing device, wherein the receiver is capable of receiving the operating information from each of a plurality of the pointing devices, and the operating information processor performs the processing based on each of the received operating information in a sequence of receiving by the receiver.

The information providing device according to the fifth aspect enables the results of processing based on the operating information received from the plurality of pointing devices to be superimposed on the displayed image.

The present invention may be implemented by diversity of aspects, for example, an information providing method, an information providing device, a presentation system, an integrated circuit or a computer program for implementing the functions of any of the method, the device and the system and a recording medium in which such a computer program is recorded.

### BRIEF DESCRIPTION OF THE DRAWINGS

FIG. 1 illustrates the configuration of an information providing system;

FIG. 2 is a block diagram illustrating the internal structure of an information providing device included in the information providing system of FIG. 1;

FIG. 3 is a flowchart showing an exemplary flow of drawn image display process; and

FIG. 4A, 4B, and 4C illustrate coordinate interpolation process and drawn image generation process.

### DESCRIPTION OF THE EMBODIMENTS

Various embodiments of the invention are described, by way of example only, and with reference to the accompanying drawings.

### A. First Embodiment

(A1) Configuration of Information Providing System

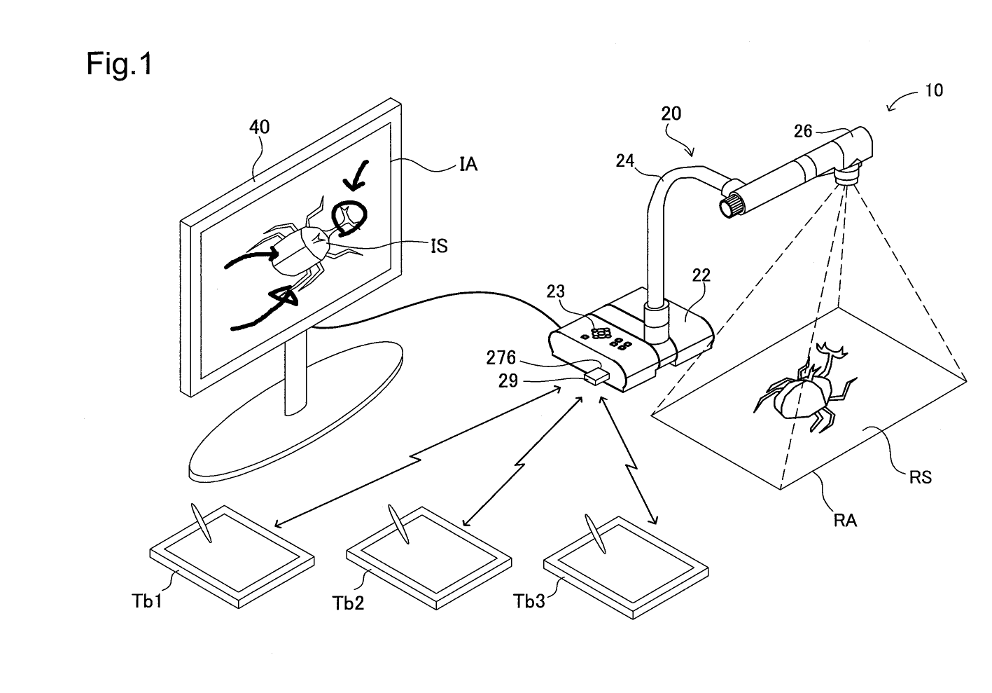

FIG. 1 illustrates the configuration of an information providing system 10 according to one embodiment of the invention. The information providing system 10 includes an information providing device 20, a television set 40, and tablets Tb1, Tb2 and Tb3 (hereinafter collectively called “tablet Tb”). The information providing device 20 and the television set 40 are interconnected by a cable for data transfer. The tablet Tb is connected to the information providing system 10 by wireless USB. In the information providing system 10, the information providing device 20 takes an image of a material RS placed on an imaging area RA of the information providing device 20 and displays the taken image as a displayed image IA on the screen of the television set 40. A displayed material IS in the displayed image IA corresponds to the material RS.

The tablet Tb transmits operating information regarding the user's operations performed on the tablet Tb to the information providing device 20 by wireless USB. The tablet Tb transmits the operating information to the information providing device 20 by wireless USB according to this embodiment, but may use another wireless technology, such as Bluetooth, infrared or wireless LAN, to transmit the operating information to the information providing device 20 according to other embodiments. The tablet Tb has two modes allowing the user to specify a position on the displayed image IA, i.e., a cursor mode and a drawing mode. The cursor mode displays a cursor, e.g., an arrow, at the position on the displayed image IA specified by the user's operation on the tablet Tb. The drawing mode enables the user to make drawing on the displayed image IA through the user's operation on the tablet Tb. The information providing system 10 includes the three tablets Tb (Tb1, Tb2 and Tb3), such that the position on the displayed image IA may be specified in the cursor mode or in the drawing mode by each of these three tablets Tb. The operations performed on the three tablets Tb are displayed in the sequence of the operations in the form of a cursor or a drawn image on the displayed image IA.

The information providing device 20 includes a main unit 22 placed on, for example, a desk, an operation unit 23 provided on the main unit 22, a support rod 24 extended upward from the main unit 22 and a camera head 26 attached to an end of the support rod 24. The camera head 26 internally has a CCD video camera and takes images of the material RS placed on, for example, the desk at a preset number of frames per unit time. In this embodiment, the information providing device 20 takes images of the material RS at the rate of 60 frames per second. A wireless USB receiver 29 for receiving the operating information from the tablet Tb is connected to a USB interface 276 provided on the main unit 22.

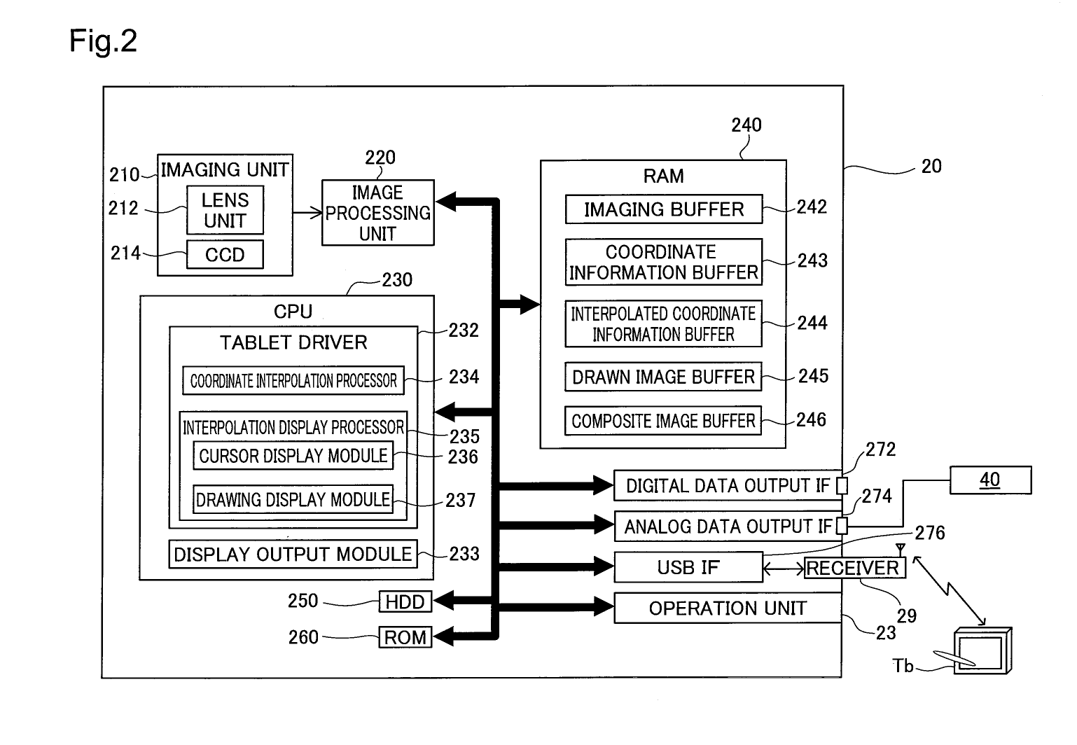

FIG. 2 is a block diagram illustrating the internal structure of the information providing device 20. The information providing device 20 includes an imaging unit 210, an image processing unit 220, a CPU 230, a RAM 240, a hard disk drive (HDD) 250 and a ROM 260. The information providing device 20 also includes a digital data output interface (digital data output IF) 272, an analog data output interface (analog data output IF) 274, the USB interface (USB IF) 276 and the operation unit 23. A receiver receiving the operating information from the tablet Tb, i.e., or the wireless USB receiver 29, is connected to the USB IF 276.

The imaging unit 210 includes a lens unit 212 and a charge-coupled device (CCD) 214. The CCD 214 serves as an image sensor to receive light transmitted through the lens unit 212 and convert the received light into electrical signal. The image processing unit 220 includes an AGC (Automatic Gain Control) circuit and a DSP (Digital Signal Processor). The image processing unit 220 inputs the electrical signal from the CCD 214 and generates taken image data. The taken image data generated by the image processing unit 220 is stored in an imaging buffer 242 provided in part of the RAM 240.

The CPU 230 controls the operations of the whole information providing device 20 and reads and executes a program stored in the HDD 250 or the ROM 260 to serve as a tablet driver 232 and a display output module 233. The tablet driver 232 refers to the operating information received from the tablet Tb via the receiver 29 and performs processing based on the operating information. When there is no process performed based on the operating information received from the tablet Tb, for example, no process of displaying a cursor or a drawn image, the display output module 233 outputs the taken image stored in the imaging buffer 242, as a displayed image, to the television set 40 via the analog data output IF 274. When there is any process performed based on the received operating information, on the other hand, the display output module 233 outputs the result of the operating information-based process along with the taken image stored in the imaging buffer 242, as a displayed image, to the television set 40 via the digital data output IF 272 or via the analog data output IF 274.

The tablet driver 232 includes a coordinate interpolation processor 234 and an interpolation display processor 235. The interpolation display processor 235 includes a cursor display module 236 and a drawing display module 237. The details of these processors 234 and 235 will be described later.

The RAM 240 includes regions respectively serving as the imaging buffer 242, a coordinate information buffer 243, an interpolated coordinate information buffer 244, a drawn image buffer 245 and a composite image buffer 246. The imaging buffer 242 stores taken image data generated by the image processing unit 220 that processes an image taken by the imaging unit 210. The coordinate information buffer 243 stores information regarding the coordinates included in the operating information received from the tablet Tb (hereinafter called “coordinate information”). The interpolated coordinate information buffer 244 stores interpolated coordinate information obtained by interpolating a change in coordinates within a preset period of time represented by the coordinate information with a change in coordinates within a shorter period of time. The drawn image buffer 245 stores drawn image data representing a drawn image created by the user's operations on the tablet Tb. The composite image buffer 246 stores composite image data representing a composite image created by superimposing the drawn image or the cursor on the taken image.

The digital data output IF 272 encodes the taken image data or the composite image data and outputs the encoded image data in the form of digital signal to the outside of the information providing device 20. The analog data output IF 274 processes the taken image data or the composite image data by digital-to-analog conversion and outputs the converted image data in the form of RGB data to the outside of the information providing device 20. The analog data output IF 274 includes a D-A converter (DAC). The digital data output IF 272 and the analog data output IF 274 respectively have a connector for cable connection. In this embodiment, the television set 40 is connected to the analog data output IF 274.

(A2) Drawn Image Display Process

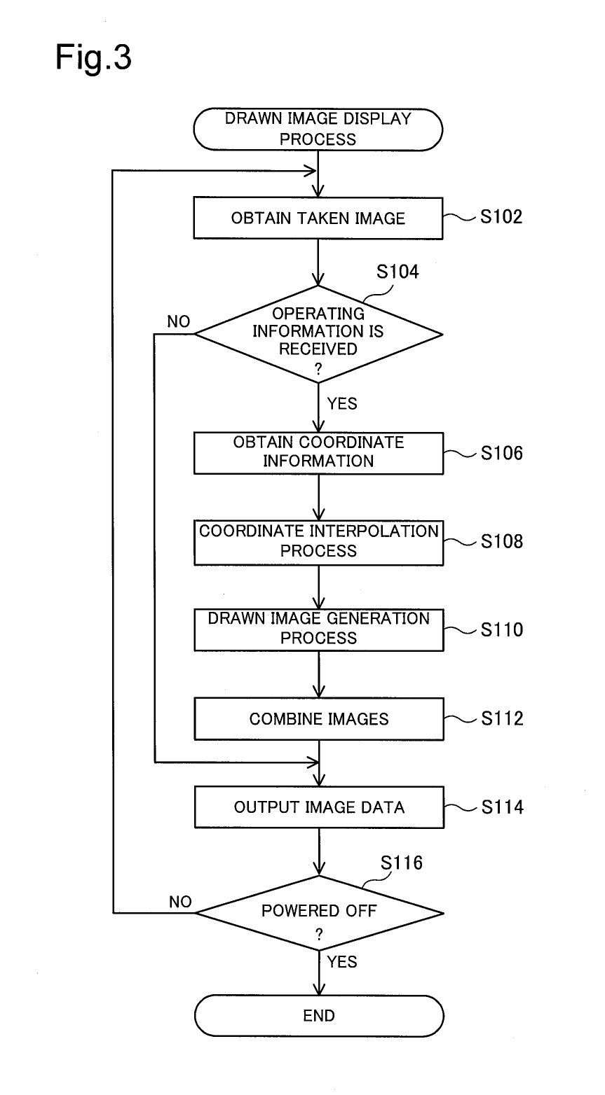

The drawn image display process performed by the information providing system 10 is described below. The drawn image display process displays a drawn image created by the user's operations on the tablet Tb, on the screen of the television set 40 serving as the image display device. FIG. 3 is a flowchart showing an exemplary flow of drawn image display process performed by the CPU 230. The drawn image display process is triggered by the user's operation of the operation unit 23 to select the drawing mode after power-on of the information providing device 20. At the start of the drawn image display process, the CPU 230 obtains taken image data generated by the imaging unit 210 and the image processing unit 220 and stores the taken image data into the imaging buffer 242 (step S102). When receiving the operating information regarding the user's drawing operation performed on the tablet Tb (step S104: Yes), the CPU 230 stores coordinate information included in the received operating information into the coordinate information buffer 243 (step S106). Until receiving the operating information (step S104: No), the CPU 230 outputs the taken image data stored in the imaging buffer 242 to the television set 40 via the analog data output IF 274 (step S114).

When receiving the operating information from the tablet Tb and storing the coordinate information into the coordinate information buffer 243, the CPU 230 performs coordinate interpolation process to interpolate a change in coordinates represented by the coordinate information and generate interpolated coordinate information and stores the interpolated coordinate information into the interpolated coordinate information buffer 244 (step S108). The CPU 230 then performs drawn image generation process to generate drawn image data based on the interpolated coordinate information (step S110).

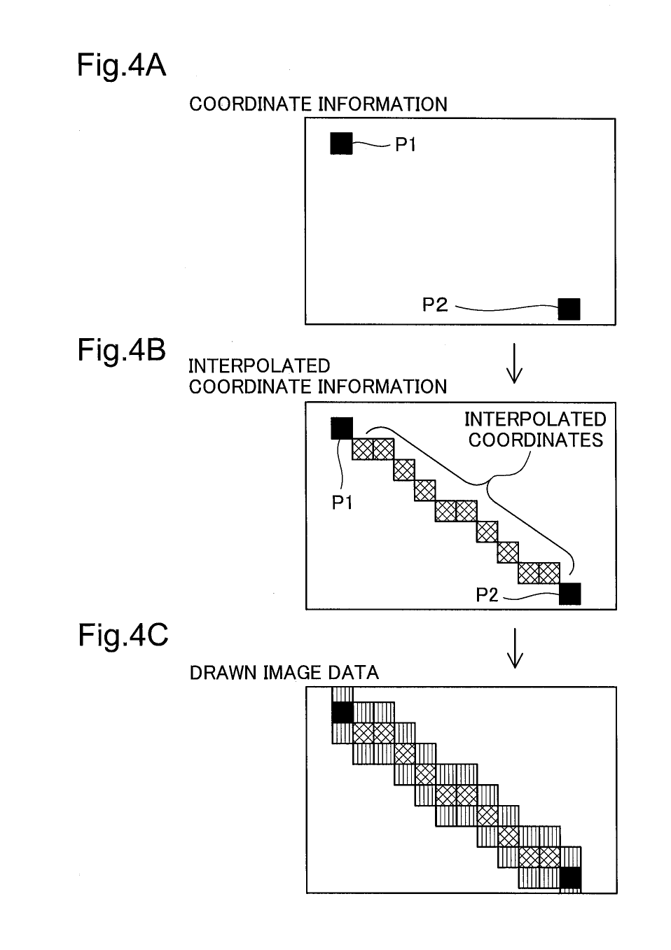

The coordinate interpolation process and the drawn image generation process are described more specifically. FIG. 4A, 4B, and 4C illustrate the coordinate interpolation process and the drawn image generation process. The coordinate information stored by the CPU 230 into the coordinate information buffer 243 indicates coordinates acquired by the tablet Tb (hereinafter called “obtained coordinates”) at the rate of 120 Hz as a change in coordinates specified by the user's drawing operation on the tablet Tb. FIG. 4A illustrates obtained coordinates P1 and P2 acquired by the tablet Tb. The obtained coordinates P1 and P2 are based on the panel on the tablet Tb used for specifying the position during the user's drawing operation. It is here assumed that the tablet Tb first acquires the obtained coordinates P1 and, after 1/120 second, acquires the obtained coordinates P2. According to the coordinate interpolation process, the CPU 230 generates interpolated coordinates between the obtained coordinates P1 and the obtained coordinates P2 acquired at the interval of 1/120 second. FIG. 4B illustrates generation of interpolated coordinates between the obtained coordinates P1 and the obtained coordinates P2 by the CPU 230. After generating the interpolated coordinates, the CPU 230 serves as the drawing display module 237 to generate a drawn image corresponding to the user's drawing operation, based on the obtained coordinates P1 and P2 and the interpolated coordinates. More specifically, the CPU 230 adds supplementary information, such as the thickness and the color of the lines drawn by the user, to the obtained coordinates P1 and P2 and the interpolated coordinates. FIG. 4C illustrates supplementary generation of coordinates corresponding to the thickness of the lines drawn by the user, in addition to the obtained coordinates P1 and P2 and the interpolated coordinates, as part of the drawn image generation process performed by the CPU 230.

The drawn image display process is explained further by referring back to FIG. 3. The CPU 230 combines the drawn image data generated by the drawn image generation process (step S110) with the taken image data stored in the imaging buffer 242 to generate composite image data and stores the composite image data into the composite image buffer 246 (step S112). The composite image data represents a composite image created by superimposing the drawn image on the taken image. After generating the composite image data, the CPU 230 serves as the display output module 233 to output the composite image data to the television set 40 via the analog data output IF 274 (step S114). The CPU 230 repeats the above series of processing until the information providing device 20 is powered off or until the drawing mode is terminated (step S116).

The above description of the drawn image display process is on the assumption that the information providing device 20 receives the operating information from the tablet Tb. In the actual state, however, the information providing device 20 receives the operating information from the three tablets Tb1, Tb2 and Tb3 and performs the drawn image display process. The CPU 230 processes the operating information in the sequence of reception from the respective tablets Tb1, Tb2 and Tb3.

When the user selects the cursor mode through the operation of the operation unit 23, the CPU 23 generates cursor image data representing a cursor image moving with time on the received obtained coordinates and interpolated coordinates, combines the cursor image data with the taken image data to generate composite image data, and serves as the display output module 233 to output the composite image data to the television set 40 via the analog data output IF 274. According to this embodiment, the information providing device 20 obtains the taken image data at the rate of 60 frames/second and displays the taken image data as a displayed image on the television set 40. Even when the cursor image is generated based on only the obtained coordinates acquired at the rate of 120 Hz, the cursor movement can be displayed as a smooth continuous motion. When the number of frames obtained per unit time and displayed as a displayed image by the information providing device 20 increases to, for example, 240 frames/second or 360 frames/second, the cursor image is generated based on the interpolated coordinates in addition to the obtained coordinates. The cursor movement can thus be displayed as a smooth continuous motion on the displayed image.

As described above, the information providing system 10 performs processing based on the wirelessly-received operating information regarding the user's operations on the tablet Tb. The information providing device 20 includes the tablet driver 232 as the processor for processing the operating information and accordingly does not require any separate computer for processing the operating information. This facilitates installation, wiring and transport of the information providing system 10.

In the drawing mode, the information providing device 20 acquires the obtained coordinates from the tablet Tb and generates a drawn image based on the obtained coordinates. Compared with the configuration wherein the tablet Tb generates drawn image data (e.g., bitmap data) representing a drawn image and wirelessly transfers the drawn image data to the information providing device 20, this configuration reduces the data volume to be transferred and saves the storage capacity of the tablet Tb for storing the generated drawn image data and the storage capacity of the information providing device 20 for storing the received drawn image data.

The information providing system 10 allows individual users to operate a plurality of wireless tablets Tb (tablets Tb1, Tb2 and Tb3 in the embodiment) for the drawing operations and the cursor movements. There is accordingly no need to use cables for connecting the pointing devices (tablet Tb in the embodiment) to the information providing device 20, and there is no cable disconnection or failure.

Each of the tablets Tb is identifiable by a wireless USB address or an ID allocated to the tablet Tb, so that the information providing device 20 can process the signals received from the respective tablets Tb by time-sharing system as the operating information of different drawing operations on the respective tablets Tb. The processing results of the operating information received from the respective tablets may be displayed discriminatively in different forms for the respective tablets, for example, different colors, different thicknesses or different densities of lines. In the field of education, for example, such discriminative display allows for the new form of a lesson that enables a number of students to individually operate the tablets Tb and perform the drawing operations on the displayed image. Alternatively, the processing results of the operating information from the plurality of tablets Tb may be displayed in the identical form, e.g., color, type and thickness of the lines.

According to another embodiment, the information providing device 20 may be designed to have a selecting switch for selecting which of a plurality of tablets is to be valid. According to yet another embodiment, the information providing device 20 may be designed to have a prohibiting switch for prohibiting the display of the processing results, while a plurality of tablets are all valid. In the latter case, the processing may continue even during the display prohibiting period, and the processing results may be displayed simultaneously after the prohibition is dismissed. For example, the display of the processing results may be prohibited, while the individual students are giving responses to make drawing. The responses of all the students may simultaneously be displayed later. According to one embodiment, the color of the selecting switch used for selecting tablets may be set to be identical with the color of drawing. This facilitates the selection of tablets, thus improving the user's convenience. The switch for setting the validity/invalidity of the respective tablets may be provided as a hardware switch on the operation unit 23 of the information providing device 20 or may alternatively be set as a software switch. In the latter case, a menu may be opened on the screen of the television set 40, and the software switch may be set through the user's operations of the tablet Tb.

The tablet driver 232, the coordinate interpolation processor 234, and the interpolation display processor 235 of the above embodiment respectively correspond to the operating information processor, the interpolator, and the interpolation display module described in the accompanying claims of the invention.

### B. Modifications

The invention is not limited to the above embodiment, but various modifications including modified examples described below may be made to the embodiment without departing from the scope of the invention. Some of possible examples are given below.

(B1) Modification 1

In the above embodiment, the wireless tablets Tb are used as the pointing device. The pointing device is, however, not limited to this example but may be wireless mice. The wireless mice may be used in combination with the wireless tablets Tb. For example, part of the plurality of tablets Tb may be replaced by mice or one or more tablet may be used along with one or more mouse. Another pointing device, such as a trackpad or a trackball, may be used instead of the tablet or the mouse.

(B2) Modification 2

In the above embodiment, the television set 40 is used as the image display device for displaying images. The image display device is, however, not limited to this example but may be any other suitable display device, such as a projector or a liquid crystal display. Such modification ensures the similar advantageous effects to those of the embodiment described above.

(B3) Modification 3

Part of the functions implemented by the software configuration in the above embodiment may be implemented by the hardware configuration, whilst part of the functions implemented by the hardware configuration in the above embodiment may be implemented by the software configuration.

What is claimed is:

1. An information providing apparatus equipped with a camera, comprising:
a single housing;
an imaging unit configured to take an image of a preset area with the camera and obtain the taken image;
a display output module configured to display the taken image as a displayed image on an image display device;
a receiver configured to wirelessly receive operating information, which regards a user's operation performed via a pointing device and includes at least coordinates-related information, from the pointing device; and
an operating information processor configured to perform processing based on the received operating information and display a result of the processing to be superimposed on the displayed image, wherein
the imaging unit, the display output module, the receiver, and the operating information processor are all accommodated in the single housing.

2. The information providing apparatus according to claim 1, wherein the pointing device is a tablet terminal having a plane and enabling the user to specify a position on the plane and thereby specify a position on the displayed image.

3. The information providing apparatus according to either one of claim 1, wherein
the operating information includes coordinate information for identifying a change in position on the displayed image specified by the user via the pointing device as a change in coordinates within a preset period of time, and
the operating information processor comprises:
an interpolator configured to interpolate the change in coordinates within the preset period of time identified by the coordinate information with interpolated coordinate information representing a change in coordinates within a shorter period of time than the preset period of time; and
an interpolation display module configured to display a change in position on the displayed image specified by the user via the pointing device to be superimposed on the displayed image, based on the interpolated coordinate information.

4. The information providing apparatus according to either one of claim 2, wherein
the operating information includes coordinate information for identifying a change in position on the displayed image specified by the user via the pointing device as a change in coordinates within a preset period of time, and
the operating information processor comprises:
an interpolator configured to interpolate the change in coordinates within the preset period of time identified by the coordinate information with interpolated coordinate information representing a change in coordinates within a shorter period of time than the preset period of time; and
an interpolation display module configured to display a change in position on the displayed image specified by the user via the pointing device to be superimposed on the displayed image, based on the interpolated coordinate information.

5. The information providing apparatus according to claim 3, wherein
when the user performs a drawing operation as the operation performed via the pointing device,
the interpolation display module comprises a drawing display module configured to generate a drawn image corresponding to the user's drawing operation, based on the interpolated coordinate information regarding a change in position on the displayed image specified by the user during the drawing operation via the pointing device, and superimpose the drawn image on the taken image to generate a composite drawn image, and
the display output module displays the composite drawn image, in place of the taken image, on the image display device.

6. The information providing apparatus according to claim 4, wherein
when the user performs a drawing operation as the operation performed via the pointing device,
the interpolation display module comprises a drawing display module configured to generate a drawn image corresponding to the user's drawing operation, based on the interpolated coordinate information regarding a change in position on the displayed image specified by the user during the drawing operation via the pointing device, and superimpose the drawn image on the taken image to generate a composite drawn image, and
the display output module displays the composite drawn image, in place of the taken image, on the image display device.

7. The information providing apparatus according to claim 1, wherein
the receiver is capable of receiving the operating information from each of a plurality of the pointing devices, and
the operating information processor performs the processing based on each of the received operating information in a sequence of receiving by the receiver.

8. The information providing apparatus according to claim 2, wherein
the receiver is capable of receiving the operating information from each of a plurality of the pointing devices, and
the operating information processor performs the processing based on each of the received operating information in a sequence of receiving by the receiver.

9. The information providing apparatus according to claim 3, wherein
the receiver is capable of receiving the operating information from each of a plurality of the pointing devices, and
the operating information processor performs the processing based on each of the received operating information in a sequence of receiving by the receiver.

10. The information providing apparatus according to claim 4, wherein
the receiver is capable of receiving the operating information from each of a plurality of the pointing devices, and
the operating information processor performs the processing based on each of the received operating information in a sequence of receiving by the receiver.

11. The information providing apparatus according to claim 5, wherein
the receiver is capable of receiving the operating information from each of a plurality of the pointing devices, and
the operating information processor performs the processing based on each of the received operating information in a sequence of receiving by the receiver.

12. The information providing apparatus according to claim 6, wherein
the receiver is capable of receiving the operating information from each of a plurality of the pointing devices, and
the operating information processor performs the processing based on each of the received operating information in a sequence of receiving by the receiver.
